(19) United States
(12) Patent Application Publication
(10) Pub. No.: US 2004/0095775 A1
(43) Pub. Date: May 20, 2004

(54) Floor lamp

(76) Inventor: Perry H. Monitto, Setauket, NY (US)

Correspondence Address: Paul J. Farrell, DILWORTH & BARRESE, LLP, 333 Earle Ovington Blvd., Uniondale, NY, 11553, US

(21) Appl. No.: 10/629,147

(22) Filed: Jul. 28, 2003

Related U.S. Application Data
(60) Provisional application No. 60/398,695, filed on Jul. 26, 2002.

(51) Int. Cl. F21V 17/00

(52) U.S. Cl. 362/441; 362/431

(57) ABSTRACT

A floor lamp used as a display device as well as an illumination device includes a pedestal and a base having an upper part, which is provided with a light source, and a lower part. The base is attached at the lower part to the pedestal in such a manner that the ratio of the length of the base to the width of the pedestal is less than or equal to 6:1 in one aspect.

### CROSS REFERENCE TO RELATED APPLICATIONS

This application is based on and fully incorporates U.S. Provisional Application No. 60/398,695 filed with the U.S. Patent and Trademark Office on Jul. 26, 2002.

### BACKGROUND OF THE INVENTION

1. Field of the Invention

The present invention relates to floor lamps, and particularly, to safe-standing floor lamps.

2. Description of the Prior Art

Display device lamps such as liquid motion lamps are placed in rooms for decorative as well as for the purpose of illumination. These display device lamps usually include transparent or translucent glass containers known as globes that contain a material that displays certain properties when heated. Frequently, however, the glass container is not shatter-proof, and therefore, care is needed when handling these display device lamps, especially when they contain heated substances.

Because of these conditions, the existing display device lamps are usually made to be placed on tabletops or other flat surfaces, and are not normally made to be free standing. Sometimes, however, there are not enough furniture surface spaces available to accommodate such display device lamps. Accordingly, there is a need to have a free standing floor display device lamp that can be safely placed on the floor. It would be also desirable to have the free standing floor display device lamp conform to the regulations and standards set by Underwriters Laboratories (“U.L.”). For example, to meet the tip test standard set by U.L., a floor lamp must not fall when tilted at a predetermined angle.

### SUMMARY OF THE INVENTION

To ensure safety of standing floor lamps, particularly liquid motion lamps, there is provided a floor lamp with predetermined dimensions to prevent accidental falls and tipovers. The floor lamp includes a pedestal and a base having at least upper and lower parts. The base is attached at the lower part to the pedestal. In one aspect, the upper part of the base is attachable to a light source, for example, a light bulb, for providing light therefrom. A container, for example, a glass container, is attached to the upper part of the base, wherein light from the light source illuminates and heats the container.

In one aspect, the container includes a liquid motion lamp globe displaying liquid motion of material contained inside. The floor lamp may be used as a display device as well as an illumination device. To ensure safety of the floor lamp when standing, the ratio of the length of the base to the width of the pedestal is made to be less than or equal to 10:1. A particularly advantageous structure in which the base and pedestal are made from the same material either as an one-piece body or a multi-part body, the length of the base/width of the pedestal ratio is less than or equal than 6:1.

In accordance with another aspect of the invention, a pedestal of the floor lamp is assembled of multiple segments capable of displacing relative to one another to increase the overall width of the support surface. Advantageously, the multiple parts are configured to move selectively to accommodate the unevenness of the support structures juxtaposed with the pedestal.

It is therefore an aspect of the invention to provide a floor lamp characterized by increased safety of standing and resistance to accidental falls and tipovers.

A further aspect of the invention is to provide a floor lamp having an esthetically appealing structure characterized by its standing stability.

A further aspect of the invention is to provide a structure of floor lamp capable of adjusting the width of its pedestal to improve its safety of standing.

### BRIEF DESCRIPTION OF THE DRAWINGS

The above and other features, objects and advantages will become more readily apparent from the detailed description accompanied by the following drawings, in which:

FIG. 1 is a perspective view of the floor lamp in one embodiment;

FIG. 2 is a top view of a housing having a light source in one embodiment;

FIG. 3 is an isometric view of one embodiment of a pedestal configured in accordance with the invention;

FIG. 4 is a cross-sectional view of the pedestal shown in FIG. 3; and

FIG. 5 is a view of another embodiment of the pedestal of a floor lamp configured in accordance with the invention.

### DETAILED DESCRIPTION

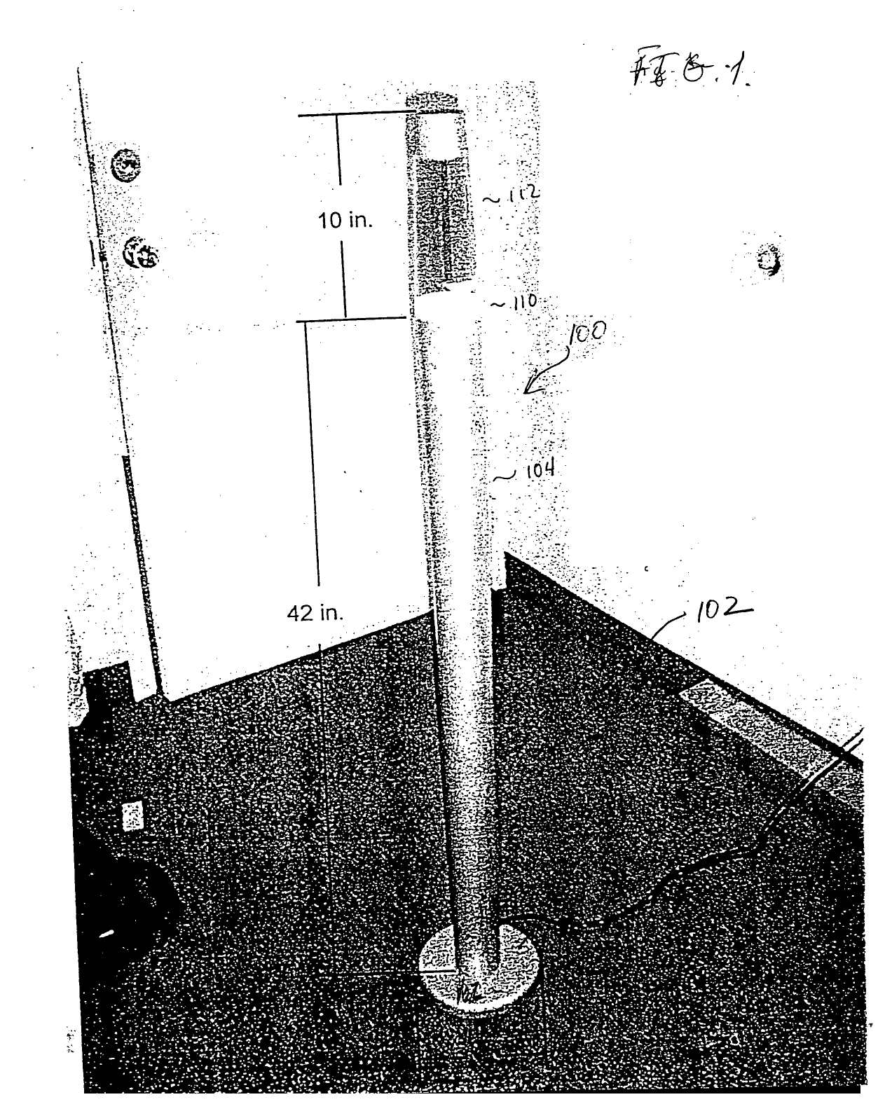

FIG. 1 illustrates a floor lamp in one embodiment. A pedestal 102 may be a substantially horizontal platform made to stand on its own and to support the rest of the floor lamp. A base 104 is attached at its lower part to the pedestal 102, for example, at the center of the pedestal 102. The base 104 is further attached at its upper part or parts to a housing 110 having a light source such as a light bulb attached to it. For example, the housing 110 may include a light bulb socket for receiving a light bulb. Electrical power to the light source is provided by conducting wires threaded through the base 104 and the housing 110. In one aspect, the housing 110 may be an integral part of the base 104. A container 112, for example, a glass container, is attached at its underside to the housing 110, such that the light from the light source in the housing 110 is directed to the underside of the container 112, thus providing illumination as well as heat to the container 112.

In one aspect, the housing 110 and the container 112 may function as a liquid motion lamp. Such liquid motion lamps contain at least two different material, which when heated and cooled, rise and fall over one another. This movement of the material provides an interesting display in the container 112. In another aspect, the container 112 may include other types of material for display.

To ensure that the floor lamp does not fall when tipped at a predetermined angle, the ratio of the length of the base 104 to the width of the pedestal preferably is made to be less than or equal to 10:1, and more than or equal to 5:1 when the pedestal and the base are constructed of the same material, without additional weighting of the pedestal. Preferably, the ratio of the cumulative length of the base 104, the housing 110, and the container 112 to the width of the pedestal is between 7:1 and 5:1, preferably 6:1. For example, FIG. 1 shows a base 104 with 42 inches in length attached to a pedestal 102 having an 8-inch diameter. In addition, a container 112 being up to 10 inches in length may be attached to the housing without creating the hazard of the floor lamp falling when tipped at a predetermined angle.

The pedestal may be substantially circular in shape as shown in FIG. 1. In this case, the width of the pedestal is its diameter. The base 104 and the container 112 also may be cylindrical, frusto-conical, or conical, or any other shape, to fit the esthetic needs of various consumers. The container 112 may be made of transparent or translucent material such as glass or any other suitable material.

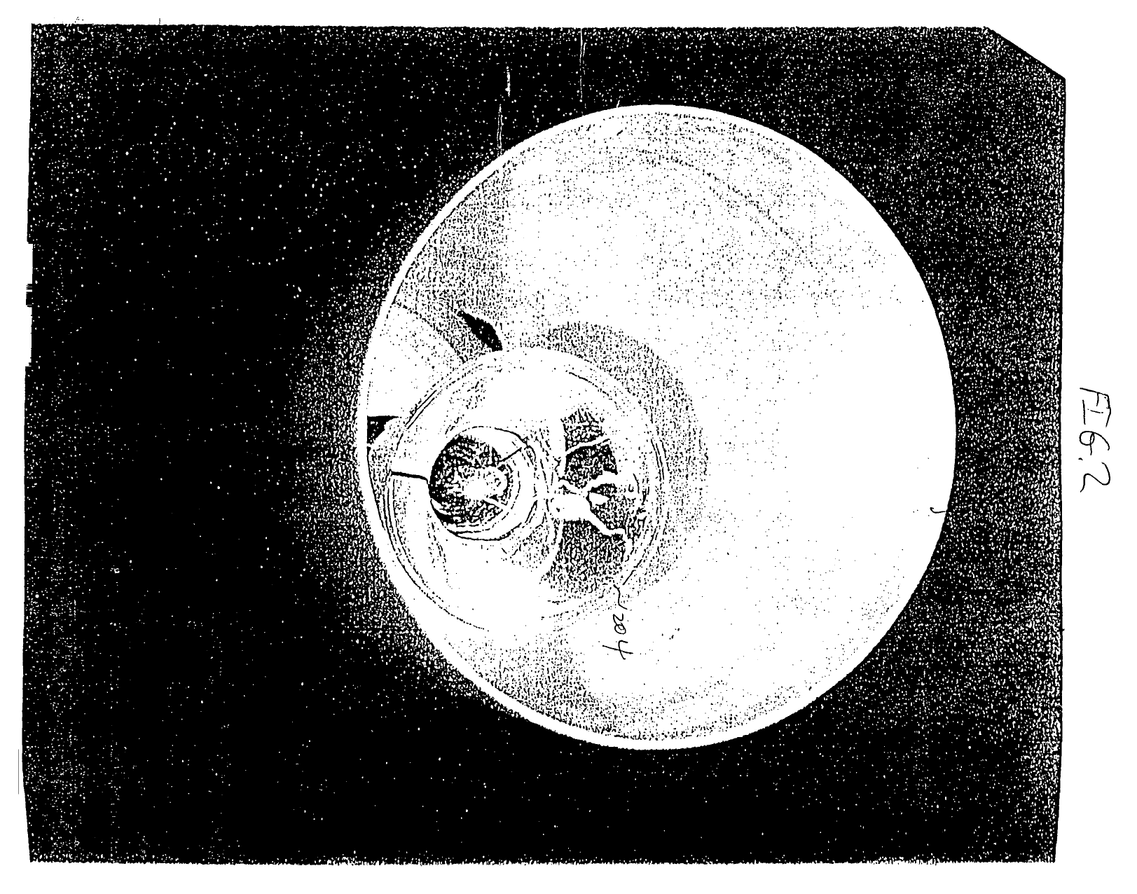

FIG. 2 is a top plan view of a housing having a light source in one embodiment. The housing 202 includes a light source, for example, a light bulb 204, attached to the housing 202 and directed upwards. In another aspect, the light source may be attached to the housing 202 in a different direction, for example, sideways. The inner side of the housing 202 may be coated with reflective material to direct light to desired directions. The light directed part of the housing 202 is then attached to the underside of the container 112 (FIG. 1) for illuminating the container. In one aspect, the housing 202 may be an integral part of the base 104.

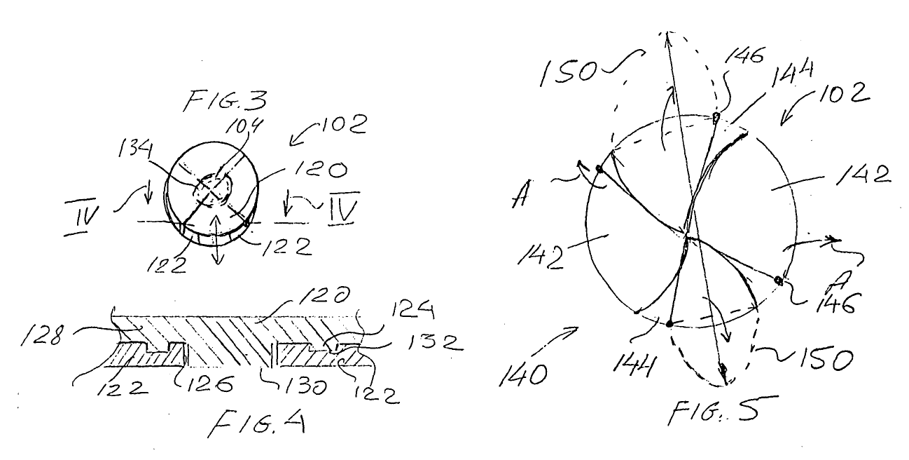

Often times the floor or any other structure supporting the floor lamp 100 can be uneven, inclined or defective. To preserve the stability of the inventive floor lamp 100, the pedestal 102 can be made of multiple parts displaceable relative to one another so as to increase its overall width. Referring to FIGS. 3 and 4, the pedestal 102 may be configured to have a multiplicity of segments 120 each, for example, provided with a generally a T-shaped cross-section, as shown in FIG. 4. Base elements 122 shaped and dimensioned to extend under shoulders 128 of the segment 120 are dimensioned to be positioned flush with a bottom 130 of the segment. To increase the overall width of the pedestal 102, the shoulders 128 of the segment 120 and base element 122 have mating guiding formations 124 and 132 shaped so as to allow the segment and the base elements to slide relative to one another. By selectively displacing segments or base elements 104, it is possible to determine the most stable position under the circumstance. In this configuration, the base may be integrally formed with either the base elements 122 or with the segments 120. The shape of the segments can vary in accordance with the desired design of the pedestal, as can the shape and location of the formations 124, 132 subject only to relative displacement of the base elements and segments. As illustrated, the bottom of the shoulder 128 has downward projections 124 slidable along the grooves 132 formed on the top surface of the base elements 122. However, this type of guiding elements or any other suitable configuration thereof can be formed, for example, on side surfaces of the segment and the associated base elements, as indicated by numeral 126. The bottom end of the base 104 may be provided with a peripheral recess 134 (FIG. 3) receiving the inner ends of displaceable segments of the base elements to provide an esthetically appealing strcuture.

A further embodiment is illustrated in FIG. 5 and includes a flower configuration 140 of the pedestal 102. A plurality of displaceable curved segments 142 alternate with stationary narrow lands 144 so that each of the curve segments is capable of pivoting along a direction “A” in a position, as shown by phantom lines 150, about a respective fulcrum 146 formed on the adjacent stationary land. Similarly to the embodiment shown in FIGS. 3 & 4, the segments 142 can be selectively displaced away from the base 102 of the floor lamp 100 to define a larger diameter D of the pedestal and to provide the latter with additional resistance to accidental falls and tipovers.

While the invention has been described with reference to several embodiments, it will be understood by those skilled in the art that the invention is not limited to the specific forms shown and described. For example, although the floor lamp has been described to include liquid motion lamps, other displayable devices may be used instead in conjunction with the floor lamp described. Thus, various changes in form and details may be made therein without departing from the spirit and scope of the invention as defined by the appended claims.

We claim:

1. A floor lamp, comprising:
a pedestal;
a base having at least upper and lower parts, the base being attached at the lower part to the pedestal, and the ratio of the length of the base to the width of the pedestal being less than or equal to 6:1;
a housing attached to the upper part of the base and attachable to a light source for providing light therefrom; and
a container having at least an underside, the underside being attached to the housing,
wherein the light from the light source in the housing can be directed to the underside of the container.

2. The floor lamp of claim 1, wherein the container includes at least two materials and the movement of at least one of the at least two materials inside the container is displayed when the light from the light source in the housing is applied to the container.

3. The floor lamp of claim 1, wherein the ratio of the cumulative length of the base, the housing, and the container to the width of the pedestal is less than 7:1.

4. The floor lamp of claim 1, wherein the ratio of the width of the base to the width of the pedestal is greater than 5:1.

5. The floor lamp of claim 1, wherein the light source includes a light bulb.

6. The floor lamp of claim 1, wherein the housing is integrally attached to the base.

7. The floor lamp of claim 1, wherein the pedestal is substantially circular in shape.

8. The floor lamp of claim 1, wherein the base is substantially frusto-conical in shape.

9. The floor lamp of claim 1, wherein the pedestal is configured to have a plurality of portions selectively displaceable relative to the base so as to modify the width of the pedestal and to increase stability of the floor lamp.

10. The floor lamp of claim 9, wherein the plurality of portions of the pedestal include multiple segments and base elements, each of the multiple segments having a generally T-shaped cross-section configured to have a foot and two shoulders, the base elements each being juxtaposed with an underside of the shoulders and slidably coupled therewith so that the base elements and the segments are slidable relative to one another.

11. The floor lamp of claim 10, further comprising a plurality of guiding elements including multiple mating formations formed between the base elements and the segments.

12. The floor lamp of claim 9, wherein the portions are selectively pivotal from a rest position, in which the portions are cumulatively configured so as to provide a substantially continuous outer periphery of the pedestal having a relatively small diameter, to an extended position, in which the pedestal has a relatively large diameter.

13. A floor lamp, comprising:
a pedestal;
a base having at least upper and lower parts, the base being attached at the lower part to the pedestal;
a liquid motion lamp container having a light source contained therein and attached at the upper parts of the base, wherein
the ratio of the length of the base to the width of the pedestal is less than or equal to 6:1.

14. The floor lamp of claim 13, wherein the ratio of the cumulative length of the base and the liquid motion lamp container to the width of the pedestal is less than or equal to 7:1.

15. The floor lamp of claim 13, wherein the pedestal is substantially circular in shape and the width of the pedestal includes the diameter of the pedestal.

16. The floor lamp of claim 13, wherein the base is substantially cylindrical in shape.

17. The floor lamp of claim 13, wherein the liquid motion lamp container is substantially cylindrical in shape.

18. A floor lamp, comprising:
a pedestal;
a base having at least upper and lower parts, the base being attached at the lower part to the pedestal, and the ratio of the length of the base to the width of the pedestal being less than or equal to 6:1, the upper part of the base being attachable to a light source for providing light therefrom; and
a container having at least an underside, the underside being attached to the upper part of the base,
wherein the light from the light source illuminates the container through the underside of the container.

19. The floor lamp of claim 18, wherein the container is transparent or translucent.

20. The floor of claim 18, wherein the pedestal has a plurality of portions displaceable relative to on another and to the base to modify a width of the pedestal.
